(19) United States
(12) Patent Application Publication
(10) Pub. No.: US 2025/0037030 A1
(43) Pub. Date: Jan. 30, 2025

(54) METHOD FOR DETERMINING A MODEL INPUT AND COMMUNICATION DEVICE

(71) Applicant: VIVO MOBILE COMMUNICATION CO., LTD., Dongguan (CN)

(72) Inventors: Ang YANG, Dongguan (CN); Peng SUN, Dongguan (CN); Jialin LI, Dongguan (CN); Bule SUN, Dongguan (CN)

(73) Assignee: VIVO MOBILE COMMUNICATION CO., LTD., Dongguan (CN)

(21) Appl. No.: 18/914,047

(22) Filed: Oct. 11, 2024

Related U.S. Application Data
(63) Continuation of application No. PCT/CN2023/087739, filed on Apr. 12, 2023.

(30) Foreign Application Priority Data
Apr. 14, 2022 (CN) 202210390701.5

(51) Int. Cl. G06N 20/00

(52) U.S. Cl. CPC G06N 20/00

(57) ABSTRACT

This application discloses a method for determining a model input and a communication device. The method for determining the model input includes: a first communication device determines an input of an AI model based on configuration information of the AI model. The configuration information is used to instruct to select N elements from a first domain as the input of the AI model. N is an integer greater than or equal to 1, the first domain includes M elements, and M is an integer greater than N.

### CROSS-REFERENCE TO RELATED APPLICATIONS

This application is a continuation of International Application No. PCT/CN 2023/087739, filed on Apr. 12, 2023, which claims priority to Chinese Patent Application No. 202210390701.5, filed on Apr. 14, 2022. The entire contents of each of the above-referenced applications are expressly incorporated herein by reference.

### TECHNICAL FIELD

This application pertains to the field of communication technologies, and in particular, to a method for determining a model input and a communication device.

### BACKGROUND

In a communication system, a communication device (for example, a terminal or a network side device) may usually perform model prediction on an input resource by using an Artificial Intelligence (AI) model, and a result of the model prediction may assist the communication device in performing channel estimation, signal processing, and the like.

Currently, when the communication device performs model prediction by using the AI model, an input of the model is usually a fixed resource location and/or a fixed resource quantity. However, in an actual communication system, resources available to the communication device is not the fixed resource location and/or resource data. In this way, when the resources available to the communication device is inconsistent with the input of the AI model, the AI model cannot be used for model prediction, resulting in a poor flexibility and generalization capability of the AI model.

### SUMMARY

Embodiments of this application provide a method for determining a model input and a communication device.

According to a first aspect, a method for determining a model input is provided, and the method includes:

A first communication device determines an input of an AI model based on configuration information of the AI model, where the configuration information is used to instruct to select N elements from a first domain as the input of the AI model, N is an integer greater than or equal to 1, the first domain includes M elements, and M is an integer greater than N.

According to a second aspect, an apparatus for determining a model input is provided, and the apparatus includes:
a determining module, configured to determine an input of an AI model based on configuration information of the AI model, where the configuration information is used to instruct to select N elements from a first domain as the input of the AI model, N is an integer greater than or equal to 1, the first domain includes M elements, and M is an integer greater than N.

According to a third aspect, a communication device is provided. The communication device includes a processor and a memory, where the memory stores a program or an instruction that can be run on the processor, and the program or the instruction is executed by the processor to implement the steps of the method according to the first aspect.

According to a fourth aspect, a communication device is provided, including a processor and a communication interface. The processor is configured to determine an input of an AI model based on configuration information of the AI model, where the configuration information is used to instruct to select N elements from a first domain as the input of the AI model, N is an integer greater than or equal to 1, the first domain includes M elements, and M is an integer greater than N.

According to a fifth aspect, a readable storage medium is provided. The readable storage medium stores a program or an instruction, where the program or the instruction is executed by a processor to implement the steps of the method according to the first aspect.

According to a sixth aspect, a chip is provided. The chip includes a processor and a communication interface, where the communication interface is coupled to the processor, and the processor is configured to run a program or an instruction to implement the method according to the first aspect.

According to a seventh aspect, a computer program/program product is provided. The computer program/program product is stored in a storage medium, and the computer program/program product is executed by at least one processor to implement the steps of the method for determining the model input according to the first aspect.

In the embodiments of this application, a communication device may determine an input of an AI model based on configuration information of the AI model, where the configuration information is used to instruct to select N elements from M elements of a first domain as the input of the AI model, N is an integer greater than or equal to 1, and M is an integer greater than N. In this way, the communication device may flexibly select the N elements from the M elements of the first domain as the input of the AI model. Therefore, the communication device can use as few AI models as possible in a case of a different resource location and/or a different resource quantity, thereby improving a use flexibility and a generalization capability of the AI model, and reducing overheads of the communication system.

### BRIEF DESCRIPTION OF DRAWINGS

FIG. 1 is a schematic diagram of a wireless communication system according to an embodiment of this application;

FIG. 2 is a schematic flowchart of a method for determining a model input according to an embodiment of this application;

FIG. 3 is a schematic diagram of a structure of an apparatus for determining a model input according to an embodiment of this application;

FIG. 4 is a schematic diagram of a structure of a communication device according to an embodiment of this application;

FIG. 5 is a schematic diagram of a structure of a communication device according to an embodiment of this application; and

FIG. 6 is a schematic diagram of a structure of a communication device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in this specification and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6^{th} Generation (6G) communication system.

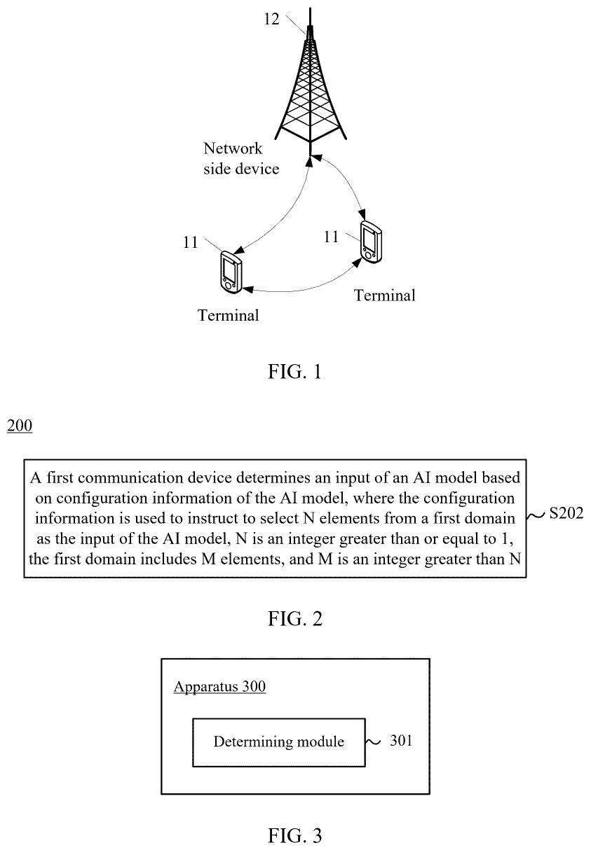

FIG. 1 is a block diagram of a wireless communication system to which the embodiments of this application may be applied. The wireless communication system includes terminals 11 and a network side device 12. The terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), smart household (household devices with wireless communication functions, such as a refrigerator, a television, a washing machine, or furniture), a game console, a Personal Computer (PC), a teller machine, or a self-service machine. The wearable device includes a smart watch, a smart band, smart earphones, smart glasses, smart jewelry (a smart bracelet, a smart hand chain, a smart ring, a smart necklace, a smart bangle, a smart anklet, or the like), a smart wristband, smart clothes, and the like. It should be noted that a specific type of the terminal 11 is not limited in the embodiments of this application. The network side device 12 may include an access network device or a core network device. The access network device 12 may also be referred to as a radio access network device, a Radio Access Network (RAN), a radio access network function, or a radio access network unit. The access network device 12 may include a base station, a Wireless Local Area Network (WLAN) access node, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the art. As long as a same technical effect is achieved, the base station is not limited to a specified technical term. It should be noted that, in the embodiments of this application, only a base station in an NR system is used as an example, but a specific type of the base station is not limited.

With reference to the accompanying drawings, a method for determining a model input and a communication device provided in the embodiments of this application is described in detail by using some embodiments and application scenarios thereof.

As shown in FIG. 2, an embodiment of this application provides a method 200 for determining a model input. The method may be executed by a first communication device. The first communication device may be a terminal or a network side device in the embodiment shown in FIG. 1. In other words, the method may be executed by using software or hardware installed in the terminal or the network side device. The method includes the following step.

S202: The first communication device determines an input of an AI model based on configuration information of the AI model, where the configuration information is used to instruct to select N elements from a first domain as the input of the AI model, N is an integer greater than or equal to 1, the first domain includes M elements, and M is an integer greater than N.

In this embodiment, when performing model prediction by using the AI model, the first communication device may select the N elements from the M elements of the first domain as the input of the AI model based on the configuration information of the AI model, where N is an integer greater than or equal to 1, and M is an integer greater than N. In this way, the first communication device may flexibly select the N elements from the M elements of the first domain as the input of the AI model, so that the input of the AI model is no longer a fixed resource location and/or a fixed resource quantity. Therefore, the communication device can use as few AI models as possible in a case of a different resource location and/or a different resource quantity, thereby improving a use flexibility and a generalization capability of the AI model, and reducing overheads of the communication system.

In some embodiments, in an embodiment, the AI model may be used in the first communication device. In this case, both the AI model and the configuration information of the AI model may be obtained by configuration by the first communication device. The first communication device may be a terminal or a network side device.

That is, in a case that the terminal uses the AI model, the terminal may configure the AI model and the configuration information of the AI model. When using the AI model, the terminal may flexibly select the N elements from the M elements of the first domain as the input of the AI model based on the configuration information. In a case that the network side device uses the AI model, the network side device may configure the AI model and the configuration information of the AI model. When using the AI model, the network side device may flexibly select the N elements from the M elements of the first domain as the input of the AI model based on the configuration information.

In some embodiments, in an embodiment, the AI model may be used in the first communication device. In this case, the AI model and the configuration information of the AI model may be configured by a second communication device for the first communication device. The first communication device is a terminal, and the second communication device is a network side device; the first communication device is a network side device, and the second communication device is a terminal; the first communication device is a first terminal, and the second communication device is a second terminal; or the first communication device is a first network side device, and the second communication device is a second network side device.

That is, in a case that the terminal uses the AI model, both the AI model and the configuration information of the AI model may be configured by the network side device for the terminal, or configured by another terminal for the terminal. In a case that the network side device uses the AI model, both the AI model and the configuration information of the AI model may be configured by the terminal for the network side device, or configured by another network side device for the network side device.

It should be noted that, in a case that the AI model and the configuration information of the AI model is configured by the second communication device for the first communication device, the second communication device may configure the AI model and the configuration information of the AI model for the first communication device at a same time, or may separately configure the AI model and the configuration information of the AI model for the first communication device at different times. In addition, the AI model and the configuration information of the AI model may be configured by a same second communication device for the first communication device, or may be configured by different second communication devices for the first communication device. For example, in a case that the AI model and the configuration information of the AI model is configured by the network side device for the terminal, a network side device 1 may configure the AI model and the configuration information of the AI model for the terminal, or a network side device 1 may configure the AI model for the terminal, and a network side device 2 may configure the configuration information of the AI model for the terminal.

In a case that the AI model and the configuration information of the AI model is configured by the second communication device for the first communication device, before determining the input of the AI model based on the configuration information of the AI model, the first communication device may receive the AI model and the configuration information of the AI model that are sent by the second communication device. That is, the second communication device may first send the AI model and the configuration information of the AI model to the first communication device. When performing model prediction by using the AI model, the first communication device may select the N elements from the M elements of the first domain as the model input of the AI model based on the configuration information of the AI model received from the second communication device.

In some embodiments, in an embodiment, the first domain may include at least one of the following:
frequency domain; time domain; space domain; Doppler domain; delay domain; or beam domain.

That is, when determining the model input of the AI model based on the configuration information, the first communication device may select the N elements from the M elements of any one or more domains of the frequency domain, the time domain, the space domain, the Doppler domain, the delay domain, or the beam domain as the input of the AI model. The first communication device may select the N elements from at least one domain of the frequency domain, the time domain, the space domain, the Doppler domain, the delay domain, or the beam domain as the input of the AI model, so that flexibility of the input of the AI model can be further improved, and a generalization capability of the AI model can be improved.

In this embodiment, the first communication device supports using the M elements in the first domain, that is, the M elements in the first domain are a working range of the first communication device. For example, if the first domain is frequency domain, and the first communication device supports 50 Resource Blocks (RBs) in the frequency domain, then M=50. For another example, if the first domain is time domain, and the first communication device supports 12 Orthogonal Frequency Division Multiplexing (OFDM) symbols in the time domain, then M=12.

In some embodiments, in an embodiment, the M elements in the first domain may be obtained in any one of the following manners:
configured by the second communication device for the first communication device;
reported by the second communication device to the first communication device;
defined by the first communication device;
specified by a protocol; or
obtained by converting a second domain, where the second domain is provided by a specified module in the first communication device or provided by a specified module in the second communication device.

For example, if the first communication device is a terminal, and the second communication device is a network side device, then the first domain may be configured by the second communication device for the first communication device; if the first communication device is a network side device, and the second communication device is a terminal, then the first domain may be reported by the second communication device to the first communication device; or if the first communication device is a terminal or a network side device, the first domain may be defined by the first communication device, specified by a protocol, or obtained by converting the second domain.

The foregoing second domain may be provided by a specified module in the first communication device or provided by a specified module in the second communication device. That is, the input of the AI model is an output of another module, the output of the another module is the second domain, and the another module may be the specified module in the first communication device or the specified module in the second communication device. In a case that the another module provides the second domain, the second domain needs to be converted into the first domain before being used as the input of the AI model.

For example, the another module provides the AI model with space domain information and frequency domain information, that is, the second domain is space domain and frequency domain, while the first domain is beam domain and delay domain. In this case, Discrete Fourier Transform (DFT) needs to be performed on the space domain of the second domain and Inverse Discrete Fourier Transform (IDFT) needs to be performed on the frequency domain of the second domain. That is, the space domain is converted to the beam domain and the frequency domain is converted to the delay domain before the space domain and the frequency domain can be used as the input of the AI model.

In this embodiment, when the first communication device selects the N elements from the M elements in the first domain based on the configuration information, the selected N elements may include any one of the following three cases:
Case 1: The N elements are N elements at a specified location in the first domain, consecutive N elements at a specified location, or consecutive N elements at an equal interval at a specified location;
Case 2: The N elements are N elements at any location, consecutive N elements at any location, or consecutive N elements at an equal interval at any location in the first domain; or
Case 3: The N elements are N elements at any location in a specified area of the first domain, consecutive N elements at any location, or consecutive N elements at an equal interval at any location, where a total quantity of elements in the specified area is greater than N and less than or equal to M.

In the foregoing Case 1, locations of the N elements in the first domain are specified and cannot be changed. The first communication device may select N elements at a corresponding location in the first domain based on the specified location. The location of the N elements in the first domain may be indicated by the configuration information.

Specifically, in a case that the N elements are the N elements at the specified location, the configuration information may include location information of each element in the N elements in the first domain. In this way, when selecting the N elements as the input of the AI model based on the configuration information, the first communication device may select the N elements at a corresponding position in the first domain based on the location information of the N elements indicated in the configuration information.

In a case that the N elements are the consecutive N elements at the specified location, the configuration information may include start location information, intermediate location information, and/or end location information of the N elements in the first domain. That is, the configuration information may include location information of a first element in the N elements, location information of any element in a second element to an (N−1)^{th} element in the N elements, and/or location information of a last element (that is, an N^{th} element) in the N elements. In this way, when selecting the N elements as the input of the AI model based on the configuration information, the first communication device may select, based on the start location information indicated in the configuration information, an element at the location and consecutive N−1 elements following the element as the input of the AI model; select, based on the intermediate location information indicated in the configuration information, consecutive N elements with an element at the location as an intermediate element as the input of the AI model; and/or select, based on the end location information indicated in the configuration information, an element at the location and consecutive N−1 elements preceding the element as the input of the AI model.

For example, if an element in the first domain is an RB, and the configuration information indicates that start location information (that is, a start ID) of a first RB in N RBs is 1, and N is 5, then five consecutive RBs whose ID set is [1 2 3 4 5] may be selected from the first domain as the input of the AI model.

In a case that the N elements are the consecutive N elements at an equal interval at the specified location, the configuration information may include interval information of the N elements as well as start location information, intermediate location information, and/or end location information of the N elements in the first domain. That is, the configuration information may include interval information of the N elements, location information of a first element in the N elements, location information of any element in a second element to an (N−1)^{th} element in the N elements, and/or location information of a last element (that is, an N^{th} element) in the N elements. In this way, when selecting the N elements as the input of the AI model based on the configuration information, the first communication device may select, based on the interval information and the start location information that are indicated in the configuration information, an element at the location and consecutive N−1 elements at an equal interval following the element as the input of the AI model; select, based on the interval information and the intermediate location information that are indicated in the configuration information, consecutive N elements at an equal interval with an element at the location as an intermediate element as the input of the AI model; and/or select, based on the interval information and the end location information that are indicated in the configuration information, an element at the location and consecutive N−1 elements at an equal interval preceding the element as the input of the AI model. An interval between the consecutive N elements at an equal interval may be a fixed value (for example, 2) or any value in a preset range (for example, any integer in a range of [2, 5]).

For example, if an element in the first domain is an RB, and the configuration information indicates that start location information of a first RB in N RBs is 1, interval information is two RBs, and N is 5, then five RBs at an equal interval whose ID set is [1 3 5 7 9] may be selected from the first domain as the input of the AI model.

In the foregoing Case 2, locations of the N elements in the first domain are arbitrary. When the first communication device selects the N elements from the first domain, the selected N elements may be N elements at any location, or may be consecutive N elements at any location, for example, from an X1^{th} element of the first domain, elements at locations [X1 X1+1 X1+2 . . . X1+N1−1] may be selected as the input of the AI model, and a value range of X1 is [1, N2−N1+1]. Alternatively, the N elements selected from the first domain may be N elements at an equal interval at any location, where the equal interval may be a fixed value or any value in a preset range.

In the foregoing Case 3, the N elements are located in a specified area of the first domain, and the specified area may be indicated by the configuration information. In the specified area, locations of the N elements are arbitrary. When selecting the N elements from the first domain, the first communication device may select N elements from a specified area of the first domain. The N elements may be N elements at any location in the specified area, may be consecutive N elements at any location in the specified area, or may be N elements at an equal interval at any location in the specified area, and the equal interval may be a fixed value or any value in a preset range.

For example, there are M elements in the first domain, one specified area is selected from the M elements, and the specified area includes M1 elements, where M1≤M. If the first domain includes 20 RBs, and a fifth RB to a twelfth RB are selected from the 20 RBs as a specified area, then the first communication device may select, based on the configuration information of the AI model, five RBs, five consecutive RBs, or five consecutive RBs at an equal interval at any location in the specified area as the input of the AI model.

In some embodiments, in an embodiment, to further improve flexibility and a generalization capability of the AI model, the AI model may cover the first domain. In this case, the N elements need to satisfy at least one of the following conditions:
in a case that there is one AI model, the N elements are the N elements at any location, the consecutive N elements at any location, or the consecutive N elements at an equal interval at any location in the first domain; or
in a case that there is a plurality of AI models, a set of a plurality of the N elements covers the first domain, and one of the N elements corresponds to one AI model.

That is, in a case that there is one AI model, to enable the AI model to cover the first domain, any N elements may be selected from the M elements in the first domain as the input of the AI model. The N elements may be N elements at any location, may be consecutive N elements at any location, or may be consecutive N elements at an equal interval at any location.

In a case that there is a plurality of AI models, a combination or a set of inputs of the plurality of AI models may cover the first domain. The plurality of AI models may be AI models with a same function or same usage. An input of each AI model includes N elements, and the N elements may be N elements, consecutive N elements, or consecutive N elements at an equal interval at a specified location; may be N elements, consecutive N elements, or consecutive N elements at an equal interval at any location; or may be N elements, consecutive N elements, or consecutive N elements at an equal interval at any location in a specified area, provided that the combination or the set of the inputs of the plurality of AI models can cover the first domain.

For example, in a case that there is three AI models and the first domain includes 20 elements, an input of an AI model 1 may be a first element to a fifth element in the first domain, an input of an AI model 2 may be any five consecutive elements in a sixth element to a fifteenth element in the first domain, an input of an AI model 3 may be any five elements in a thirteenth element to a twentieth element, and a set of the input elements of the three AI models covers the first domain.

In this embodiment, after determining the N elements, that is, after selecting the N elements from the first domain as the input of the AI model based on the configuration information, the first communication device may input the N elements into the AI model, to perform model prediction based on the N elements and the AI model.

In some embodiments, in an embodiment, when the N elements are input into the AI model, the N elements may be sorted. When the N elements are sorted, at least one of the following may be included:
sorting the N elements based on locations or identifiers of the N elements in the first domain in a descending order or an ascending order of the locations or the identifiers; or
sorting the N elements based on channel characteristics of the N elements in a descending order or an ascending order of the channel characteristics.

A channel characteristic of an element includes at least one of the following: a power, an amplitude, or a phase of information on the element; or a correlation between the element and another element. The another element is another element in the N elements or another element in the M elements of the first domain. The correlation may be cosine similarity, a vector correlation, a Euclidean distance, dispersion, and the like, which are not listed herein one by one. The correlation may also be a correlation after the element is projected into another space, such as a high-dimensional space, a core space, a low-dimensional space, and the like, which are not listed herein one by one.

In this embodiment, after inputting the N elements into the AI model, the first communication device may perform model prediction based on the AI model. In some embodiments, in an embodiment, the input of the AI model and the usage of the AI model may include at least one of the following (1) to (9):

(1) the AI model is used for signal processing, and the input of the AI model includes at least one of the following:
a Demodulation Reference Signal (DMRS);
a Sounding Reference Signal (SRS);
a Synchronization Signal and PBCH block (SSB);
a Tracking Reference Signal (TRS);
a Phase Tracking Reference Signal (PTRS); or
a Channel State Information Reference Signal (CSI-RS).

The foregoing signal may be an estimation result or a detection result of the signal, and the signal processing may include signal detection, filtering, equalization, and the like.

(2) The AI model is used for signal transmission, reception, demodulation, or sending,
and the input of the AI model includes at least one of the following:
a Physical Downlink Control Channel (PDCCH);
a Physical Downlink Shared Channel (PDSCH);
a Physical Uplink Control Channel (PUCCH);
a Physical Uplink Shared Channel (PUSCH);
a Physical Random Access Channel (PRACH); or
a Physical Broadcast Channel (PBCH).

(3) The AI model is configured to obtain channel state information, and the input of the AI model includes at least one of the following: Channel State Information (CSI); CSI-RS; or SRS;

For example, obtaining the channel state information may include the following two scenarios:
(A) Feedback of channel state information. The channel state information fed back may include channel related information, channel matrix related information, channel characteristic information, channel matrix characteristic information, a Precoding Matrix Indicator (PMI), Rank Indication (RI), a CSI-RS Resource Indicator (CRI), a Channel Quality Indicator (CQI), a Layer Indicator (LI), and the like.
(B) Frequency Division Duplexing (FDD) uplink and downlink partial reciprocity.

For an FDD system, based on partial reciprocity of uplink and downlink channels, a network side device obtains angle information and delay information based on an uplink channel, and may notify a terminal of the angle information and the delay information through CSI-RS precoding or direct indication, and the terminal reports the channel state information or selects and reports the channel state information within an indication range of the network side device based on an indication of the network side device, thereby reducing a calculation amount of the terminal and overheads of CSI reporting.

(4) The AI model is used for beam management, and the input of the AI model includes at least one of the following: beam quality; or beam information.

The beam management may include beam measurement, beam reporting, beam prediction, beam failure detection, beam failure recovery, a new beam indication in beam failure recovery, and the like.

The beam quality may be channel quality of various reference signals used for beam management, such as a Reference Signal Received Power (RSRP), Reference Signal Received Quality (RSRQ), Signal-to-Noise and Interference Ratio (SINR) of reference signals such as SSB, CSI-RS, or SRS, and the beam quality further includes beam quality of layer 1 and/or beam quality of layer 3.

The beam information may be a beam ID, a beam direction, precoding information (a precoding vector, a precoding matrix) of a beam, or the like. The beam information may be divided by direction, for example, a horizontal dimension beam ID, a vertical dimension beam ID, a horizontal dimension beam direction, a vertical dimension beam direction, or the like.

(5) The AI model is used for channel prediction, and the input of the AI model includes at least one of the following: channel information at a historical moment; or channel information at a current moment.

The channel prediction may include channel state information prediction, beam prediction, and the like.

(6) The AI model is used for interference suppression, and the input of the AI model includes at least one of the following: a signal; or interference.

The interference may include intra-cell interference, inter-cell interference, out-of-band interference, cross modulation interference, and the like.

(7) The AI model is used for positioning, and the input of the AI model includes at least one of the following: channel information of a reference signal; or information about auxiliary location estimation or track estimation.

The positioning may be used to estimate a specific location (which includes a horizontal location and/or a vertical location), a possible future track, information about auxiliary location estimation or track estimation (timing, timing advancement, time of arrival, angle of arrival), or the like of the terminal by using a reference signal (for example, an SRS, a positioning reference signal, or the like).

(8) The AI model is used for higher layer service and/or parameter prediction and management, and the input of the AI model includes at least one of the following:
a higher layer service and/or a parameter;
a service and/or a parameter of a physical layer; or
a service and/or a parameter of a Medium Access Control (MAC) layer.

The higher layer service and/or the parameter may include a throughput, a required packet size, a service requirement, a moving speed, noise information, and the like.

(9) The AI model is configured to parse control signaling, and the input of the AI model includes at least one of the following: signaling; or reception information of a control channel.

The control signaling may be signaling related to power control, signaling related to beam management, and the like. Signaling included in the input of the AI model may be physical layer signaling, MAC layer signaling, Radio Resource Control (RRC) layer signaling, higher layer signaling, or the like. The reception information of the control channel included in the input of the AI model may be reception information on a PDCCH/PUCCH.

In the embodiments of this application, a communication device may determine an input of an AI model based on configuration information of the AI model, where the configuration information is used to instruct to select N elements from M elements of a first domain as the input of the AI model, N is an integer greater than or equal to 1, and M is an integer greater than N. In this way, the communication device may flexibly select the N elements from the M elements of the first domain as the input of the AI model. Therefore, the communication device can use as few AI models as possible in a case of a different resource location and/or a different resource quantity, thereby improving a use flexibility and a generalization capability of the AI model, and reducing overheads of the communication system.

The method for determining a model input in the embodiments of this application may be executed by an apparatus for determining a model input. In this embodiment of this application, the apparatus for determining the model input provided in this embodiment of this application is described by using an example in which the apparatus for determining the model input performs the method for determining the model input.

FIG. 3 is a schematic diagram of a structure of an apparatus for determining a model input according to an embodiment of this application, where the apparatus may correspond to a first communication device in another embodiment. As shown in FIG. 3, an apparatus 300 includes the following module:
a determining module 301, configured to determine an input of an AI model based on configuration information of the AI model, where the configuration information is used to instruct to select N elements from a first domain as the input of the AI model, N is an integer greater than or equal to 1, the first domain includes M elements, and M is an integer greater than N.

In some embodiments, in an embodiment, the AI model is used in a first communication device, the AI model and the configuration information are obtained by configuration by the first communication device, and the first communication device is a terminal or a network side device.

In some embodiments, in an embodiment, the AI model is used in a first communication device, the AI model and the configuration information are configured by a second communication device for the first communication device, where
the first communication device is a terminal, and the second communication device is a network side device;
the first communication device is a network side device, and the second communication device is a terminal;
the first communication device is a first terminal, and the second communication device is a second terminal; or
the first communication device is a first network side device, and the second communication device is a second network side device.

In some embodiments, in an embodiment, the determining module 301 is further configured to:
receive the AI model and the configuration information that are sent by the second

In some embodiments, in an embodiment, the first domain includes at least one of the following:
frequency domain; time domain; space domain; Doppler domain; delay domain; or beam domain.

In some embodiments, in an embodiment, the first communication device supports using the M elements in the first domain, where
the M elements in the first domain are configured by the second communication device for the first communication device, reported by the second communication device to the first communication device, defined by the first communication device, specified by a protocol, or obtained by converting a second domain, where the second domain is provided by a specified module in the first communication device or provided by a specified module in the second communication device.

In some embodiments, in an embodiment, the N elements include any one of the following:
the N elements are N elements at a specified location, consecutive N elements at a specified location, or consecutive N elements at an equal interval at a specified location in the first domain;
the N elements are N elements at any location, consecutive N elements at any location, or consecutive N elements at an equal interval at any location in the first domain; or the N elements are N elements at any location, consecutive N elements at any location, or consecutive N elements at an equal interval at any location in a specified area of the first domain, where a total quantity of elements in the specified area is greater than N and less than or equal to M.

In some embodiments, in an embodiment, the N elements include any one of the following:
in a case that the N elements are the N elements at the specified location, the configuration information includes location information of each element in the N elements in the first domain;
in a case that the N elements are the consecutive N elements at the specified location, the configuration information includes start location information, intermediate location information, and/or end location information of the N elements in the first domain; or
in a case that the N elements are the consecutive N elements at an equal interval at the specified location, the configuration information includes interval information of the N elements as well as start location information, intermediate location information, and/or end location information of the N elements in the first domain.

In some embodiments, in an embodiment, the interval between the consecutive N elements at the equal interval is a fixed value, or is any value in a preset range.

In some embodiments, in an embodiment, the N elements satisfy at least one of the following:
in a case that there is one AI model, the N elements are the N elements at any location, the consecutive N elements at any location, or the consecutive N elements at an equal interval at any location in the first domain; or
in a case that there is a plurality of AI models, a set of a plurality of the N elements covers the first domain, and one of the N elements corresponds to one AI model.

In some embodiments, in an embodiment, the determining module 301 is further configured to:
after the N elements are determined, sort the N elements when the N elements are input into the AI model, where
the sorting the N elements includes at least one of the following:
sorting the N elements based on locations or identifiers of the N elements in the first domain in a descending order or an ascending order of the locations or the identifiers; or
sorting the N elements based on channel characteristics of the N elements in a descending order or an ascending order of the channel characteristics, where a channel characteristic of an element includes at least one of the following: a power, an amplitude, or a phase of information on the element; or a correlation between the element and another element, where the another element is another element in the N elements or another element in the M elements.

In some embodiments, in an embodiment, the AI model and the input of the AI model includes at least one of the following:
the AI model is used for signal processing, and the input of the AI model includes at least one of the following: a demodulation reference signal DMRS; a sounding reference signal SRS; a synchronization signal and physical broadcast channel block SSB; a tracking reference signal TRS; a phase tracking reference signal PTRS; or a channel state information reference signal CSI-RS;
the AI model is used for signal transmission, reception, demodulation, or sending, and the input of the AI model includes at least one of the following: a physical downlink control channel PDCCH; a physical downlink shared channel PDSCH; a physical uplink control channel PUCCH; a physical uplink shared channel PUSCH; a physical random access channel PRACH; or a physical broadcast channel PBCH;
the AI model is configured to obtain channel state information, and the input of the AI model includes at least one of the following: CSI; CSI-RS; or SRS;
the AI model is used for beam management, and the input of the AI model includes at least one of the following: beam quality; or beam information;
the AI model is used for channel prediction, and the input of the AI model includes at least one of the following: channel information at a historical moment; or channel information at a current moment;
the AI model is used for interference suppression, and the input of the AI model includes at least one of the following: a signal; or interference;
the AI model is used for positioning, and the input of the AI model includes at least one of the following: channel information of a reference signal; or information about auxiliary location estimation or track estimation;
the AI model is used for higher layer service and/or parameter prediction and management, and the input of the AI model includes at least one of the following: a higher layer service and/or a parameter; a service and/or a parameter of a physical layer; a service and/or a parameter of a media access control MAC layer; or
the AI model is configured to parse control signaling, and the input of the AI model includes at least one of the following: signaling; or reception information of a control channel.

The apparatus 300 according to this embodiment of this application may correspond to the procedures of the method 200 in the embodiment of this application, and units/modules in the apparatus 300 and the foregoing operations and/or functions are separately for implementing the corresponding procedures of the method 200, and can achieve a same or equivalent technical effect. For brevity, details are not described herein again.

The apparatus for determining the model input in this embodiment of this application may be an electronic device having an operating system, or may be a component, such as an integrated circuit, or a chip in an electronic device. The electronic device may be a terminal, or another device other than the terminal. For example, the terminal may include but is not limited to the foregoing listed types of the terminal 11. The another device may be a server, a Network Attached Storage (NAS), or the like. This is not specifically limited in the embodiments of this application.

The apparatus for determining the model input provided in this embodiment of this application can implement the processes implemented in the method embodiment of FIG. 2, and a same technical effect can be achieved. To avoid repetition, details are not described herein again.

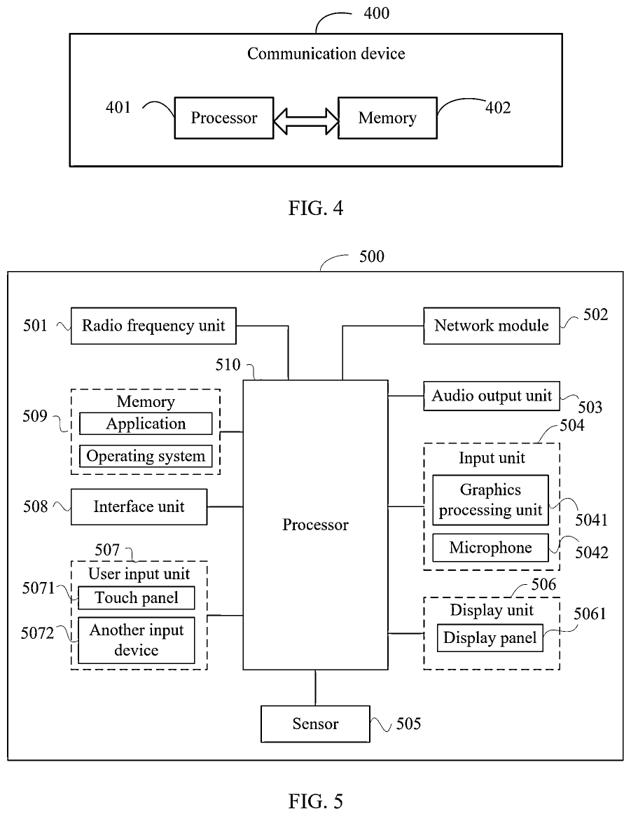

In some embodiments, as shown in FIG. 4, an embodiment of this application further provides a communication device 400, including a processor 401 and a memory 402, where the memory 402 stores a program or an instruction that can be run on the processor 401. For example, when the communication device 400 is a terminal, the program or the instruction is executed by the processor 401 to implement the steps of the foregoing embodiment of the method for determining the model input, and a same technical effect can be achieved. When the communication device 400 is a network side device, the program or the instruction is executed by the processor 401 to implement the steps of the foregoing method embodiment of the apparatus for determining the model input, and a same technical effect can be achieved. To avoid repetition, details are not described herein again.

An embodiment of this application further provides a communication device, including a processor and a communication interface. The processor is configured to determine an input of an AI model based on configuration information of the AI model, where the configuration information is used to instruct to select N elements from a first domain as the input of the AI model, N is an integer greater than or equal to 1, the first domain includes M elements, and M is an integer greater than N. The communication device embodiment corresponds to the foregoing method embodiment of the first communication device. The implementation processes and implementations of the foregoing method embodiment may be applicable to the communication device embodiment, and a same technical effect can be achieved. Specifically, FIG. 5 is a schematic diagram of a hardware structure of a communication device for implementing embodiments of this application.

A communication device 500 includes but is not limited to at least a part of components such as a radio frequency unit 501, a network module 502, an audio output unit 503, an input unit 504, a sensor 505, a display unit 506, a user input unit 507, an interface unit 508, a memory 509, and a processor 510.

A person skilled in the art can understand that the communication device 500 may further include a power supply (such as a battery) that supplies power to each component. The power supply may be logically connected to the processor 510 by using a power supply management system, to implement functions such as charging and discharging management, and power consumption management by using the power supply management system. The structure of the communication device shown in FIG. 5 does not constitute a limitation on the communication device. The communication device may include components more or fewer than those shown in the diagram, a combination of some components, or different component arrangements. Details are not described herein.

It should be understood that in this embodiment of this application, the input unit 504 may include a Graphics Processing Unit (GPU) 5041 and a microphone 5042. The GPU 5041 processes image data of a static picture or a video obtained by an image capture apparatus (for example, a camera) in a video capture mode or an image capture mode. The display unit 506 may include a display panel 5061, and the display panel 5061 may be configured in a form of a liquid crystal display, an organic light-emitting diode, or the like. The user input unit 507 includes at least one of a touch panel 5071 and another input device 5072. The touch panel 5071 is also referred to as a touchscreen. The touch panel 5071 may include two parts: a touch detection apparatus and a touch controller. The another input device 5072 may include but is not limited to a physical keyboard, a functional button (such as a volume control button or a power on/off button), a trackball, a mouse, and a joystick. Details are not described herein.

In this embodiment of this application, the radio frequency unit 501 receives downlink data from a network side device and then sends the downlink data to the processor 510 for processing; and the radio frequency unit 501 may send uplink data to the network side device. Usually, the radio frequency unit 501 includes but is not limited to an antenna, an amplifier, a transceiver, a coupler, a low noise amplifier, a duplexer, and the like.

The memory 509 may be configured to store a software program or an instruction and various data. The memory 509 may mainly include a first storage area for storing a program or an instruction and a second storage area for storing data. The first storage area may store an operating system, and an application or an instruction required by at least one function (for example, a sound playing function or an image playing function). In addition, the memory 509 may be a volatile memory or a non-volatile memory, or the memory 509 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 509 in this embodiment of this application includes but is not limited to these memories and any memory of another proper type.

The processor 510 may include one or more processing units. In some embodiments, an application processor and a modem processor are integrated into the processor 510. The application processor mainly processes an operating system, a user interface, an application, or the like. The modem processor mainly processes a wireless communication signal, for example, a baseband processor. It may be understood that, in some embodiments, the modem processor may not be integrated into the processor 510.

The processor 510 is configured to determine an input of an AI model based on configuration information of the AI model, where the configuration information is used to instruct to select N elements from a first domain as the input of the AI model, N is an integer greater than or equal to 1, the first domain includes M elements, and M is an integer greater than N.

In the embodiments of this application, a communication device may determine an input of an AI model based on configuration information of the AI model, where the configuration information is used to instruct to select N elements from M elements of a first domain as the input of the AI model, N is an integer greater than or equal to 1, and M is an integer greater than N. In this way, the communication device may flexibly select the N elements from the M elements of the first domain as the input of the AI model. Therefore, the communication device can use as few AI models as possible in a case of a different resource location and/or a different resource quantity, thereby improving a use flexibility and a generalization capability of the AI model, and reducing overheads of the communication system.

The communication device 500 provided in this embodiment of this application may further implement the processes of the foregoing 200 method embodiment, and a same technical effect can be achieved. To avoid repetition, details are not described herein again.

An embodiment of this application further provides a communication device, including a processor and a communication interface. The processor is configured to determine an input of an AI model based on configuration information of the AI model, where the configuration information is used to instruct to select N elements from a first domain as the input of the AI model, N is an integer greater than or equal to 1, the first domain includes M elements, and M is an integer greater than N. The communication device embodiment corresponds to the foregoing method embodiment of the first communication device. The implementation processes and implementations of the foregoing method embodiment may be applicable to the communication device embodiment, and a same technical effect can be achieved.

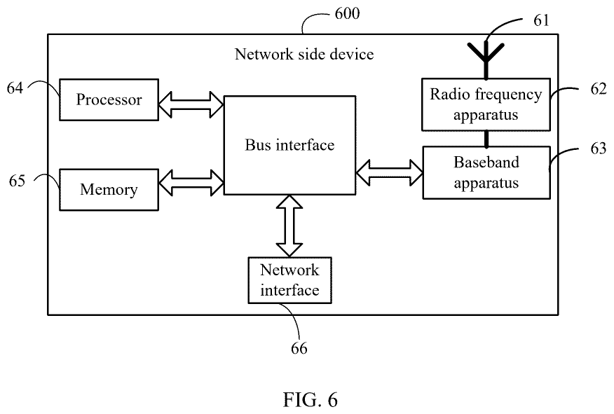

Specifically, an embodiment of this application further provides a communication device. As shown in FIG. 6, the communication device 600 includes an antenna 61, a radio frequency apparatus 62, a baseband apparatus 63, a processor 64, and a memory 65. The antenna 61 is connected to the radio frequency apparatus 62. In an uplink direction, the radio frequency apparatus 62 receives information by using the antenna 61, and sends the received information to the baseband apparatus 63 for processing. In a downlink direction, the baseband apparatus 63 processes information that needs to be sent, and sends processed information to the radio frequency apparatus 62. The radio frequency apparatus 62 processes the received information, and sends processed information by using the antenna 61.

In the foregoing embodiment, the method performed by the first communication device may be implemented in the baseband apparatus 63. The baseband apparatus 63 includes a baseband processor.

For example, the baseband apparatus 63 may include at least one baseband board. A plurality of chips are disposed on the baseband board. As shown in FIG. 6, one chip is, for example, a baseband processor, and is connected to the memory 65 through a bus interface, to invoke a program in the memory 65 to perform the operations of the first communication device shown in the foregoing method embodiment.

The communication device may further include a network interface 66, and the interface is, for example, a Common Public Radio Interface (CPRI).

Specifically, the communication device 600 in this embodiment of this application further includes an instruction or a program that is stored in the memory 65 and that can be run on the processor 64. The processor 64 invokes the instruction or the program in the memory 65 to perform the method performed by the modules shown in FIG. 6, and to achieve a same technical effect. To avoid repetition, details are not described herein again.

An embodiment of this application further provides a readable storage medium. The readable storage medium stores a program or an instruction, and the program or the instruction is executed by a processor to implement the processes of the foregoing embodiment of the method for determining the model input, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, where the communication interface is coupled to the processor, and the processor is configured to run a program or an instruction to implement the processes of the foregoing embodiment of the method for determining the model input, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor to implement the processes of the foregoing embodiment of the method for determining the model input, and a same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the implementations of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A method for determining a model input, comprising:
determining, by a first communication device, an input of an Artificial Intelligence (AI) model based on configuration information of the AI model, wherein the configuration information is used to instruct to select N elements from a first domain as the input of the AI model, N is an integer greater than or equal to 1, the first domain comprises M elements, and M is an integer greater than N.

2. The method according to claim 1, wherein
the AI model is used in the first communication device, the AI model and the configuration information are obtained through configuration by the first communication device, and the first communication device is a terminal or a network side device.

3. The method according to claim 1, wherein
the AI model is used in the first communication device, the AI model and the configuration information are configured by a second communication device for the first communication device, wherein
the first communication device is a terminal, and the second communication device is a network side device;
the first communication device is a network side device, and the second communication device is a terminal;
the first communication device is a first terminal, and the second communication device is a second terminal; or
the first communication device is a first network side device, and the second communication device is a second network side device.

4. The method according to claim 3, wherein before the determining, by the first communication device, the input of the AI model based on the configuration information of the AI model, the method further comprises:
receiving the AI model and the configuration information that are sent by the second

5. The method according to claim 1, wherein the first domain comprises at least one of the following:
frequency domain, time domain, space domain, Doppler domain, delay domain, or beam domain.

6. The method according to claim 1, wherein the first communication device supports using the M elements in the first domain, wherein
the M elements in the first domain are configured by the second communication device for the first communication device, reported by the second communication device to the first communication device, defined by the first communication device, specified by a protocol, or obtained by converting a second domain, wherein the second domain is provided by a specified module in the first communication device or provided by a specified module in the second communication device.

7. The method according to claim 1, wherein the N elements comprise any one of the following:
the N elements are N elements at a specified location, consecutive N elements at a specified location, or consecutive N elements at an equal interval at a specified location in the first domain;
the N elements are N elements at any location, consecutive N elements at any location, or consecutive N elements at an equal interval at any location in the first domain; or
the N elements are N elements at any location, consecutive N elements at any location, or consecutive N elements at an equal interval at any location in a specified area of the first domain, wherein a total quantity of elements in the specified area is greater than N and less than or equal to M.

8. The method according to claim 7, wherein:
when the N elements are the N elements at the specified location, the configuration information comprises location information of each element in the N elements in the first domain;
when the N elements are the consecutive N elements at the specified location, the configuration information comprises at least one of start location information, intermediate location information, or end location information of the N elements in the first domain; or
when the N elements are the consecutive N elements at the equal interval at the specified location, the configuration information comprises interval information of the N elements as well as at least one of the start location information, the intermediate location information, or the end location information of the N elements in the first domain.

9. The method according to claim 7, wherein
the interval between the consecutive N elements at the equal interval is a fixed value, or is any value in a preset range.

10. The method according to claim 7, wherein:
when there is one AI model, the N elements are the N elements at any location, the consecutive N elements at any location, or the consecutive N elements at the equal interval at any location in the first domain; or
when there is a plurality of AI models, a set of a plurality of the N elements covers the first domain, and one of the N elements corresponds to one AI model.

11. The method according to claim 1, further comprising:
after the N elements are determined, sorting the N elements inputted into the AI model,
wherein the sorting the N elements comprises at least one of the following:
sorting the N elements based on locations or identifiers of the N elements in the first domain in a descending order or an ascending order of the locations or the identifiers; or
sorting the N elements based on channel characteristics of the N elements in a descending order or an ascending order of the channel characteristics, wherein a channel characteristic of an element comprises at least one of the following: a power, an amplitude, or a phase of information on the element; or a correlation between the element and another element, and wherein the another element is another element in the N elements or another element in the M elements.

12. The method according to claim 1, wherein the AI model and the input of the AI model comprise at least one of the following:
the AI model is used for signal processing, and the input of the AI model comprises at least one of the following: a Demodulation Reference Signal (DMRS), a Sounding Reference Signal (SRS), a synchronization signal and physical broadcast channel block SSB, a Tracking Reference Signal (TRS), a Phase Tracking Reference Signal (PTRS), or a channel state information reference signal CSI-RS;
the AI model is used for signal transmission, reception, demodulation, or sending, and the input of the AI model comprises at least one of the following: a Physical Downlink Control Channel (PDCCH), a Physical Downlink Shared Channel (PDSCH), a Physical Uplink Control Channel (PUCCH), a Physical Uplink Shared Channel (PUSCH), a Physical Random Access Channel (PRACH), or a Physical Broadcast Channel (PBCH);
the AI model is configured to obtain channel state information, and the input of the AI model comprises at least one of the following: CSI, CSI-RS, or SRS;
the AI model is used for beam management, and the input of the AI model comprises at least one of the following: beam quality, or beam information;
the AI model is used for channel prediction, and the input of the AI model comprises at least one of the following: channel information at a historical moment, or channel information at a current moment;
the AI model is used for interference suppression, and the input of the AI model comprises at least one of the following: a signal, or interference;
the AI model is used for positioning, and the input of the AI model comprises at least one of the following: channel information of a reference signal, or information about auxiliary location estimation or track estimation;
the AI model is used for higher layer service or parameter prediction and management, and the input of the AI model comprises at least one of the following: a higher layer service or a parameter, a service or a parameter of a physical layer, or a service or a parameter of a media access control MAC layer; or
the AI model is configured to parse control signaling, and the input of the AI model comprises at least one of the following: signaling, or reception information of a control channel.

13. A communication device, comprising a processor and a memory storing instruction, wherein the instructions, when executed by the processor, cause the processor to perform operations comprising:
determining an input of an AI model based on configuration information of the AI model, wherein the configuration information is used to instruct to select N elements from a first domain as the input of the AI model, N is an integer greater than or equal to 1, the first domain comprises M elements, and M is an integer greater than N.

14. The communication device according to claim 13, wherein
the AI model is used in the first communication device, the AI model and the configuration information are obtained through configuration by the first communication device, and the first communication device is a terminal or a network side device.

15. The communication device according to claim 13, wherein
the AI model is used in the first communication device, the AI model and the configuration information are configured by a second communication device for the first communication device, wherein
the first communication device is a terminal, and the second communication device is a network side device;
the first communication device is a network side device, and the second communication device is a terminal;
the first communication device is a first terminal, and the second communication device is a second terminal; or
the first communication device is a first network side device, and the second communication device is a second network side device.

16. The communication device according to claim 15, wherein before the determining the input of the AI model based on the configuration information of the AI model, the method further comprises:
receiving the AI model and the configuration information that are sent by the second

17. The communication device according to claim 13, wherein the first domain comprises at least one of the following:
frequency domain, time domain, space domain, Doppler domain, delay domain, or beam domain.

18. The communication device according to claim 13, wherein the first communication device supports using the M elements in the first domain, wherein
the M elements in the first domain are configured by the second communication device for the first communication device, reported by the second communication device to the first communication device, defined by the first communication device, specified by a protocol, or obtained by converting a second domain, wherein the second domain is provided by a specified module in the first communication device or provided by a specified module in the second communication device.

19. The communication device according to claim 13, wherein the N elements comprise any one of the following:
the N elements are N elements at a specified location, consecutive N elements at a specified location, or consecutive N elements at an equal interval at a specified location in the first domain;
the N elements are N elements at any location, consecutive N elements at any location, or consecutive N elements at an equal interval at any location in the first domain; or
the N elements are N elements at any location, consecutive N elements at any location, or consecutive N elements at an equal interval at any location in a specified area of the first domain,
wherein a total quantity of elements in the specified area is greater than N and less than or equal to M.

20. A non-transitory computer-readable storage medium storing instructions that, when executed by a processor, cause the processor to perform operations comprising:
determining an input of an AI model based on configuration information of the AI model, wherein the configuration information is used to instruct to select N elements from a first domain as the input of the AI model, N is an integer greater than or equal to 1, the first domain comprises M elements, and M is an integer greater than N.
